(19) United States
(12) Patent Application Publication
(10) Pub. No.: US 2009/0020668 A1
(43) Pub. Date: Jan. 22, 2009

(54) SUSPENSION APPLIANCE FOR GRIPPING DEVICES

(76) Inventor: Giuseppe MAFFEIS, RONCADELLE (BRESCIA) (IT)

Correspondence Address: MCGLEW & TUTTLE, PC, P.O. BOX 9227, SCARBOROUGH STATION, SCARBOROUGH, NY, 10510-9227, US

(21) Appl. No.: 12/172,467

(22) Filed: Jul. 14, 2008

(30) Foreign Application Priority Data
Jul. 16, 2007 (IT) BS 2007 A 000096

(51) Int. Cl. F16B 47/00

(52) U.S. Cl. 248/206.2; 248/363

(57) ABSTRACT

The invention relates to a suspension device for pneumatic gripping appliances, in particular suction cups, for gripping and handling parts, items and the like. It comprises a fixed supporting body (11), a tubular rod (12) movable axially in said body, and a return spring (13) between said body and said rod. This tubular rod (12) is guided on the supporting body (11) by the interposition of a slide jacket (20) in combination with the seals (16, 19) provided to prevent the air entering from outside when a suction/depression appliance is connected to the supporting body to activate the pneumatic gripping device.

### FIELD OF THE INVENTION

The present invention relates to a suspension appliance for pneumatic gripping devices, in particular for a suction cup connectable to a suction system to control the action.

### STATE OF THE TECHNIQUE

In some sectors pneumatic gripping devices in the form of suction cups to grip and handle parts, items or for loading having surfaces the suction cups are able to grip, are already used. The suction cups can be used individually or in groups depending on the sizes and/or weight of the part or item to be moved, assembled on a supporting frame, each one by means of a suspension appliance, and connected to a vacuum apparatus. They are made to rest against a surface of the part or item to be picked up, making them adhere firmly to the suction device.

According to the known technique, a suspension appliance for the suction cups designed for the abovementioned use comprises a fixed supporting body and a movable tubular rod, guided in said body and liable to axial movements contrasted by a return spring. One end of the tubular rod is connected to, and supports, a suction cup, whereas the opposite end is jointed to a tube in communication with the vacuum apparatus. As for the return spring it is set up to allow the tubular rod to carry out variable backward so as to adapt the position of the suction cup to the surface it has to come into contact with each time and then to place the rod in a start, forward position, when the suction cup is idle and moved back from such surfaces.

Made in this way the suspension appliance is relatively simple, but has the drawback that the air tube always moves following the movements of the rod it is jointed to.

For this reason problems relating to stress and wear of the air tubes can be experienced and possible interferences and obstructions between the tubes which can sometimes hinder the action of the suction cups cannot be excluded, in particular where there are several suction cups positioned close to each other on the same supporting frame.

In the attempt to avoid such a drawback a suspension appliance has been proposed for suction cups in which the suction tube is jointed to the fixed supporting body and is placed in communication with the tubular rod holding the suction cup by means of a conduit that extends inside said body. In this way, the suction tube remains at a standstill with the supporting body, but there is the drawback that obstructions are formed in the air conduit towards the suction cup that limit the delivery of air, its function and speed of the reaction of the suction cup.

### OBJECTIVES OF THE INVENTION AND SUMMARY

One objective of the present invention is to propose a suspension appliance for pneumatic gripping devices, in particular suction cups, where the suction tube is attached and stationary with the body of the support and the air conduit towards the suction cup to be commanded; it does not have any significant obstruction so as to actually avoid the abovementioned drawbacks and known technical disadvantages.

A further objective of the invention is to provide a suspension appliance for suction cups that is efficient and reliable and furthermore with a structure that makes it particularly light, a feature that becomes important in particular in gripper systems using a number of suction cups on the same supporting frame.

Said objectives are achieved with a suspension appliance for gripper devices such as suction cups according to the preface of claim 1 and where the tubular rod is guided in the supporting body by the interposition of a slide jacket in combination with seals provided to stop air entering from the outside when a suction/vacuum device to set in motion the pneumatic gripping device is applied to the supporting body.

### BRIEF DESCRIPTION OF THE DRAWINGS

The invention will however be illustrated more in detail in the continuation of the present description made with reference to the indicative and not restrictive drawing, in which:

FIG. 1 shows a blow-up of the components of the suspension appliance;

FIGS. 2 and 3 show, respectively, a view in perspective and a side view of the assembled device;

FIG. 4 shows a cross section of the device according to arrows A-A in FIG. 3, with the rod in the extended position: and

FIG. 5 shows a similar section of the device, but with the rod in the body in the retracted position.

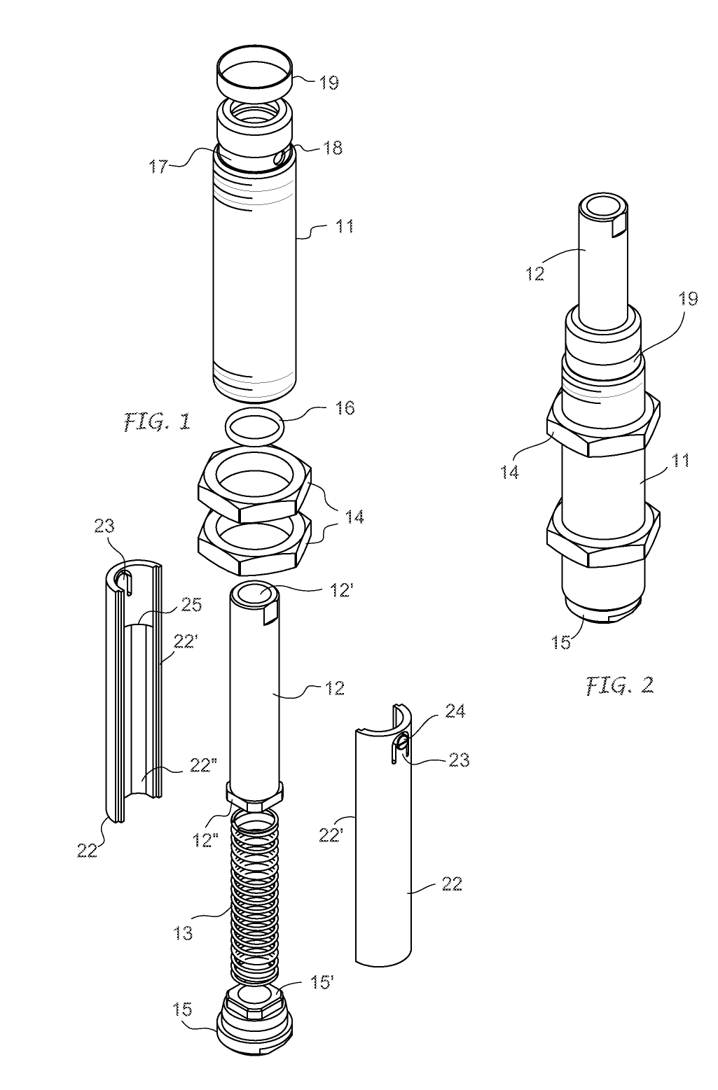

### DETAILED DESCRIPTION OF THE INVENTION

The device basically comprises a fixed supporting body 11, a movable rod 12 and return spring 13 positioned between said body and said rod.

The supporting body 11 is basically tubular and forms an axial cavity 11′. Externally it can be uniform, smooth or at least partially threaded and provided with means 14, such as nuts, to fix it to a supporting and movement frame, not shown.

At one end, the rear one of the supporting body 11, a perforated plug 15 is mounted to which a suction tube can be connected, also not shown.

At its opposite end, the front one, the supporting body 11 contains internally a seal 16, whereas externally it has a peripheral groove 17 and, in line with this, at least two diametrally opposite radial holes 18. In the peripheral groove 17 is provided a ring seal 19 that covers the radial holes 18 from the outside.

The supporting body is covered externally by a self-lubricating material jacket 20 placed in its cavity 11′ and positioned axially between the plug 15 and one end of the supporting body and a ledge 21 provided in a part of said cavity between the radial holes 18 and the front end of said body.

In the example shown, said jacket 20 is made up of two elements or semi-cylindrical opposite shells 22, that match complementarily along their longitudinal borders 22′ and each one is provided, at one of its ends, with a flexible tang 23 with a coupling tooth or rung 24 facing outwards. The elements or semi-cylindrical shells are inserted in the cavity 11′ of the rear end of the body, before mounting the plug 15, and pushed until each one engages with its respective coupling tooth or rung 24, in the radial holes 18 in line with the peripheral groove 17 of the body. Engaged in this way, the teeth or rungs 24 already act, in themselves, also as means for stabilising the jacket 20 in the body, by preventing its rotation. In addition, at least one part 22′ of the internal surface of the elements or shells that comprise the jacket 20 is faceted to conjugate with a polygonal portion 15′, or similarly faceted integral with the plug 15.

The moving rod 12 is tubular with an axial passage 12′ in line with the hole that goes through the plug 15 and whose diameter is almost the same as that of the hole. The rod 12 is housed and slides in the jacket 20 inside the supporting body and emerging from the front end of the latter with a portion to which a gripping device is connected, such as a suction cup—not shown, to be commanded. Furthermore, preferably at its base, the rod 12 has a polygonal or faceted portion 12″ designed to couple with the internal faceted surface 22″ of the jacket 20 so that the rod is free to slide longitudinally however without the possibility of turning so as to guarantee the required orientation of the suction cup connected to it.

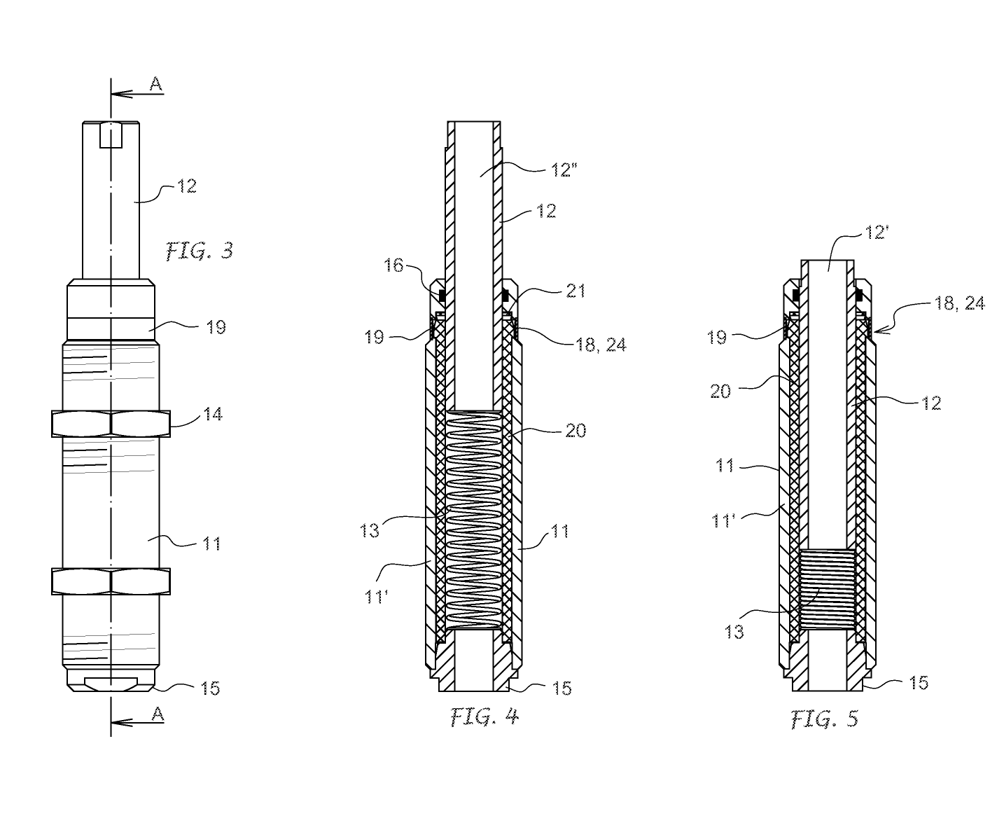

The return spring 13 is positioned and compressible between the plug 15 and the internal end of the rod 12. The latter is moveable between a forward position protruding from the front end of the body as shown in FIGS. 3 and 4 and a retracted position in said body as shown in FIG. 5. The forward position of the rod 12 is caused by the spring 13 and can be limited, for example, by its polygonal portion 12″ resting against a shoulder 25 inside the jacket 20, whereas the retracted position of the rod 12 causes the spring to become compressed which can vary depending on the position of the surface against which the suction cup is from time to time is in contact with. The suction cup placed at the end of the rod is activated by the application from the rear of suction to the suspension appliance. The internal and external seals 16 and 19 ensure a pneumatic grip between the fixed body and the movable rod during suction avoiding air entering from the circulating atmosphere ensuring in this way the efficiency of the device. In particular, the internal seal 16 operates between the rod and the fixed body preventing the air to enter between the two components in a longitudinal direction. At the same time, as soon as a depression is generated in the body because of suction up stream with the tendency to intake air from outside through the radial holes 18, the external ring seal 19 undergoes contraction and obstructs these holes causing a pneumatic seal also from that direction.

1. Suspension appliance for pneumatic gripping devices, in particular suction cups, comprising a fixed supporting body (11), a tubular rod (12) axially movable in said body, a return spring (13) between said body and said rod, where the tubular rod (12) holds at one of its ends a pneumatic gripping device and is movable in the supporting body (11) between an advanced position, in which it emerges from an end of said body by means of a return spring (13), and a retracted position, when the gripper device is in contact with the surface it has to grip by means of a suction/depression appliance applied to said body, wherein the tubular rod (12) is guided in said supporting body by the interposition of a slide jacket (20) in combination with seals (16, 19) positioned to prevent air entering from outside when a suction/depression device to activate the pneumatic gripper is connected to the supporting body.

2. Suspension appliance according to claim 1, wherein the supporting body (11) is tubular and forms an axial cavity (11′), and wherein the slide jacket (20) is positioned in said cavity between a contact ledge (21) at the end of the supporting body, from which the tubular rod (12) emerges and a plug mounted on the opposite end of said body, said plug being perforated and connectable to a tube for the suction/depression device to activate the pneumatic gripping device.

3. Suspension appliance according to claim 1, wherein said slide jacket (20) is made up of two elements or semi-cylindrical facing shells (22) that match complementarily along their longitudinal borders 22′, said elements being in an auto-lubricating material.

4. Suspension appliance according to claim 3, wherein said elements or semi-cylindrical shells (22) that make up the slide jacket (20) each have a flexible tang (23) with a tooth or rung (24) facing towards the external and designed to engage with a radial hole (18) provided in the supporting body (11) to anchor said elements to the body.

5. Suspension appliance according to claim 1, wherein between the supporting body (11) and the tubular rod (12) is inserted a seal (16) preferably close to the end of said supporting body from which said rod protrudes.

6. Suspension appliance according to claim 4, wherein said supporting body (11) is provided with a peripheral groove (17) on a level with the radial bores (18) the connecting teeth or pins of the semi-cylindrical elements (22) fit into forming the slide jacket (20), and in said groove a seal (19) is fitted which is contractible to close said bores externally (18) in response to the suction/depression appliance connected to said supporting body to activate the pneumatic gripping device.

7. Suspension appliance according to claim 3, wherein inside the slide jacket (20), in particular of the semi-cylindrical elements which form a part of it, anti-rotation means (22″) are provided that engage with corresponding anti-rotation means (12″) on at least one part of the external surface of the tubular rod (12) and also with anti-rotation means integral with the plug (15) applied to the supporting body (11).

8. Suspension appliance according to claim 1, wherein the slide jacket (20) has means for defining the forward position of the tubular rod (12), and wherein the plug or rod have a basically equal axial bore.

9. Suspension appliance according to claim 1, wherein the supporting body has either a smooth or threaded external surface with means for fixing the body to a supporting and handling frame.

10. Suspension appliance according to claim 2, wherein said slide jacket (20) is made up of two elements or semi-cylindrical facing shells (22) that match complementarily along their longitudinal borders 22′, said elements being in an auto-lubricating material.
